(19) United States
(12) Patent Application Publication
(10) Pub. No.: US 2026/0205386 A1
(43) Pub. Date: Jul. 16, 2026

(54) Technologies for Efficiently Producing Issue Tracker Tickets

(71) Applicant: The PNC Financial Services Group, Inc., Pittsburgh, PA (US)

(72) Inventors: Caleb James Abraham, Crafton, PA (US); Garrick Lance Friedlander, Gibsonia, PA (US)

(21) Appl. No.: 19/024,412

(22) Filed: Jan. 16, 2025

Related U.S. Application Data
(60) Provisional application No. 63/622,677, filed on Jan. 19, 2024.

(51) Int. Cl. H04L 41/5074; G06F 16/3329; G06F 16/34; G06Q 30/015

(52) U.S. Cl. CPC H04L 41/5074; G06F 16/33295; G06F 16/345; G06Q 30/015

(57) ABSTRACT

Technologies for efficiently generating issue tracker tickets include a compute device. The compute device includes circuitry configured to obtain a request message. The request message may be indicative of a request for assistance with a corresponding technical problem. The circuitry may be further configured to simulate a conversation among multiple experts to identify an approach to resolving the technical problem. Additionally, the circuitry may be configured to generate an issue tracker ticket based on the simulated conversation. Other embodiments are also described.

### RELATED APPLICATIONS

This application claims the benefit of U.S. Provisional Application Number 63/622,677 filed January 19, 2024 for “Technologies for Efficiently Producing Issue Tracker Tickets,” which is hereby incorporated by reference in its entirety.

### BACKGROUND

Large organizations, such as institutional banks, often have a team of software developers who develop software components (e.g., applications) to assist in the operations of the institution (e.g., to assist in management of assets, to facilitate processing of financial transactions, to provide enhanced data visualization, etc.). Such applications often undergo continual development as the needs of the organization evolve. As a side effect of the continual and contemporaneous development of multiple software components, technical problems such as incompatibilities between versions of components, incomplete feature sets, and other technical problems may arise. Organizations may use issue tracker systems that rely on tickets (e.g., descriptions of the technical problems along with additional contextual data) to memorialize the technical problems and assign one or more software developers to resolve the problems. However, generating a ticket for an issue tracker is a resource intensive process that relies on a person or a team of people to dedicate time to research the problem and describe it in an easily understandable manner that complies with the policies and practices of the organization. Given the resource intensiveness of the process, personnel, such as project managers, may devote less time to producing tickets, thereby causing technical problems to go unaddressed and hampering the operations of the organization.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for efficiently generating issue tracker tickets;

FIG. 2 is a simplified block diagram of at least one embodiment of a compute device of the system of FIG. 1;

FIGS. 3-6 are simplified block diagrams of at least one embodiment of a method for efficiently generating issue tracker tickets that may be performed by the system of FIG. 1; and

FIG. 7 is a high level diagram of relationships between components of the system of FIG. 1 in the performance of the method of FIGS. 3-6.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

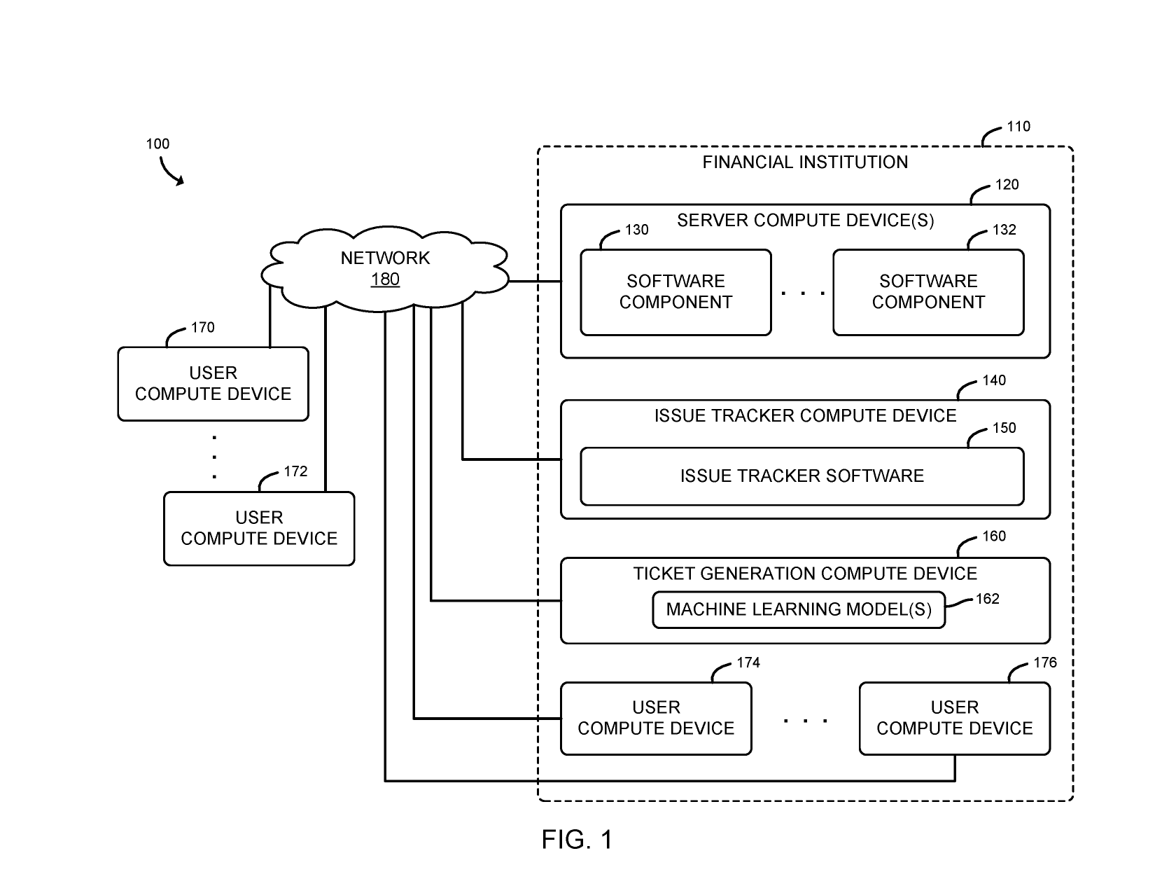

Referring now to FIG. 1, a system 100 for efficiently generating issue tracker tickets includes, in the illustrative embodiment, a set of server compute devices 120 communicatively connected to an issue tracker compute device 140 and a ticket generation compute device 160. The compute devices 120, 140, 160 are associated with a financial institution 110, such as a bank. While the system 100 and methods performed by the system 100 are described herein with reference to the financial institution 110, the system 100 and methods could be used in the context of other organizations as well. In the illustrative embodiment, users (e.g., employees of the financial institution) utilize user compute devices 170, 172, 174, 176 to access services (e.g., asset management, financial transaction processing, data visualization, etc.) provided by software components 130, 132 (e.g., executed by the server compute devices 120). One or more of the software components 130, 132 may be developed and maintained by members of a software development team associated with the financial institution 110. In the course of using the software components 130, 132, the users may encounter technical problems, such as features that do not operate as expected, incompatibilities between the software components 130, 132, and the like. As such, the users operating the user compute devices 170, 172, 174, 176 may submit reports of the technical problems to be tracked and assigned to members of the software development team by issue tracker software 150 (e.g., Jira from Atlassian Corporation, Zoho Bugtracker from Zoho Corporation, etc.) executed by the issue tracker compute device 140.

Typically, to track an issue, a person must manually prepare a ticket, which may be embodied as a set of data that includes a summary of the technical problem and a description of how the problem may be resolved. The ticket may also have a set of criteria that, when satisfied, would indicate that the issue is resolved and/or one or more associated resources (e.g., links or attachments) to assist a software developer in understanding the context of the technical problem. Creating an effective ticket, in a conventional system, may be a time consuming process as it can often require the expertise of multiple people with insights into various aspects of the environment in which the technical problem has arisen (e.g., regulatory issues, internal policies of the financial institution, technical dependencies, etc.) to collaborate and prepare a succinct summary of how to address the problem. The ticket generation compute device 160 is configured to provide more efficient (e.g., less resource intensive) creation of high quality issue tracker tickets that enable software developers to quickly understand a technical problem and factors to consider in addressing the problem. In the illustrative embodiment, the ticket generation compute device 160 utilizes one or more machine learning models 162 (e.g., data structures and/or executable instructions configured to recognize patterns and/or generate predictions) to generate a description of the technical problem, a description of technical issues that may arise in the resolution of technical problem, and related information based on a high level of familiarity with the interconnections between software components that may be impacted by any work on the technical problem, as well as the policies and procedures of the organization.

In the illustrative embodiment, the one or more machine learning models 162 are large language models (e.g., relatively large machine learning models that include a set of neural networks with an encoder and a decoder, to extract meaning from text and generate responsive text to queries), and the ticket generation compute device 160 generates the issue tracker ticket by simulating, with the large language models 162, a conversation among experts in various subject matter areas (e.g., technical, compliance with legal, regulator, or company-related policies, project management, etc.), summarizing the conversation, and formatting the ticket in accordance with the practices of the financial institution 110. Additionally, and as described in more detail herein, the system 100 (e.g., the ticket generation compute device 160) applies a set of filters to identify and remove (e.g., from a queue) requests from users that do not satisfy an initial set of qualifications (e.g., good-faith requests for assistance with technical problems) to avoid the expenditure of resources (e.g., compute resources) on errant request received by the system 100 (e.g., the ticket generation compute device 160).

While relatively few compute devices 120, 140, 160, 170, 172, 174, 176 are shown in FIG. 1 for simplicity and clarity, it should be understood that the number of compute devices, in practice, may range in the tens, hundreds, thousands, or more. Likewise, it should be understood that the compute devices 120, 140, 160, 170, 172, 174, 176 may be distributed differently or perform different roles than the configuration shown in FIG. 1. Further, though shown as separate compute devices 120, 140, 160, 170, 172, 174, 176 in some embodiments, the functionality of one or more of the compute devices 120, 140, 160, 170, 172, 174, 176 may be combined into fewer compute devices and/or distributed across more compute devices than those shown in FIG. 1.

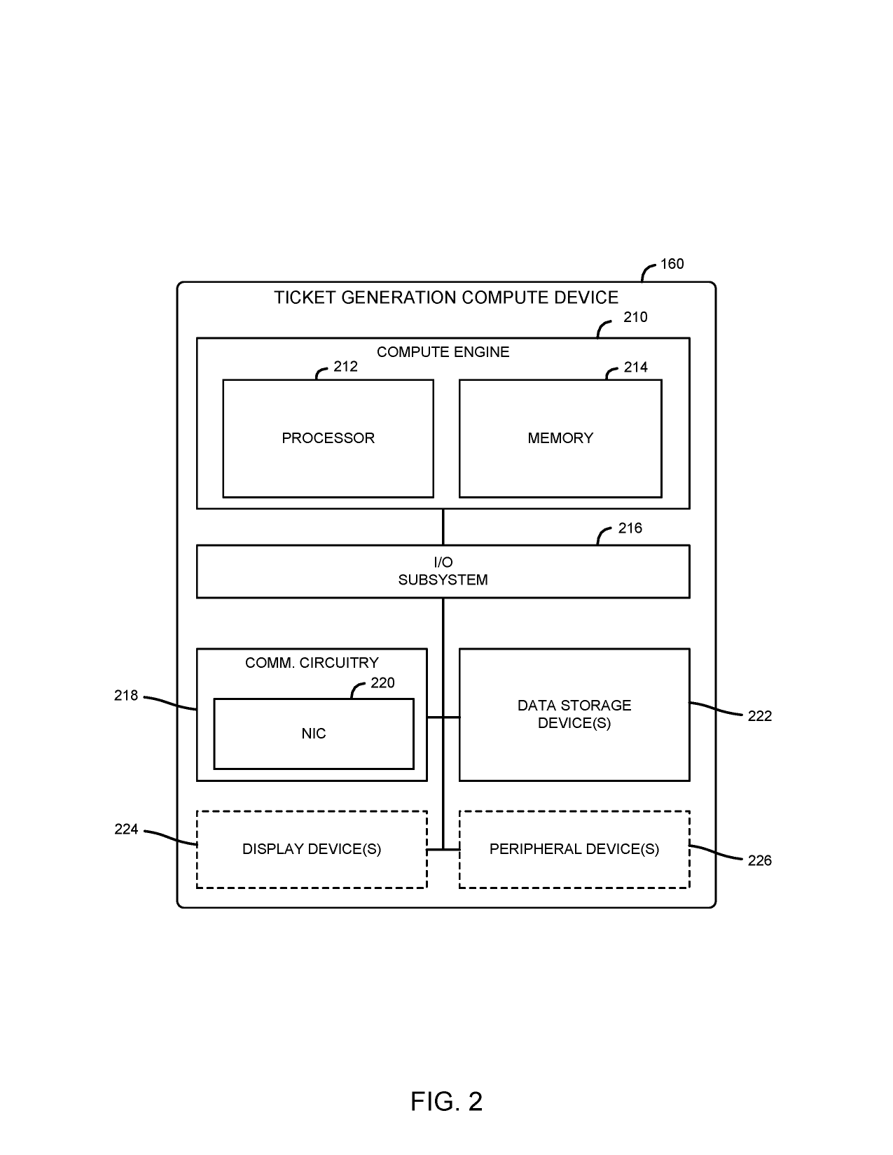

Referring now to FIG. 2, the illustrative ticket generation compute device 160 includes a compute engine 210, an input/output (I/O) subsystem 216, communication circuitry 218, and one or more data storage devices 222. In some embodiments, the ticket generation compute device 160 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the ticket generation compute device 160 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as machine learning models, request messages, issue tracker tickets, applications, libraries, and drivers.

The compute engine 210 is communicatively coupled to other components of the ticket generation compute device 160 via the I/O subsystem 216, which may be embodied as circuitry and/or components to facilitate input/output operations with the compute engine 210 (e.g., with the processor 212 and the main memory 214) and other components of the ticket generation compute device 160. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the ticket generation compute device 160, into the compute engine 210.

The communication circuitry 218 may be embodied as any communication circuit, device, or collection thereof, capable of enabling communications over a network between the ticket generation compute device 160 and another device (e.g., a compute device 120, 140, 170, 172, 174, 176, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the ticket generation compute device 160 to connect with another compute device (e.g., a compute device 120, 140, 170, 172, 174, 176, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the ticket generation compute device 160 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the ticket generation compute device 160 are housed in a single unit. However, in other embodiments, the components may be in separate housings, in separate racks of a data center, and/or spread across multiple data centers or other facilities. The compute devices 120, 140, 170, 172, 174, 176 may have components similar to those described in FIG. 2 with reference to the ticket generation compute device 160. The description of those components of the ticket generation compute device 160 is equally applicable to the description of components of the compute devices 120, 140, 170, 172, 174, 176. Further, it should be appreciated that any of the devices 120, 140, 160, 170, 172, 174, 176 may include other components, sub-components, and devices commonly found in a computing device, which are not discussed above in reference to the ticket generation compute device 160 and not discussed herein for clarity of the description.

In the illustrative embodiment, the compute devices 120, 140, 160, 170, 172, 174, 176, are in communication via a network 180, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.) cellular networks (e.g., Global System for Mobile Communications (GSM), Long Term Evolution (LTE), Worldwide Interoperability for Microwave Access (WIMAX), 3G, 4G, 5G, etc.). a radio area network (RAN), or any combination thereof.

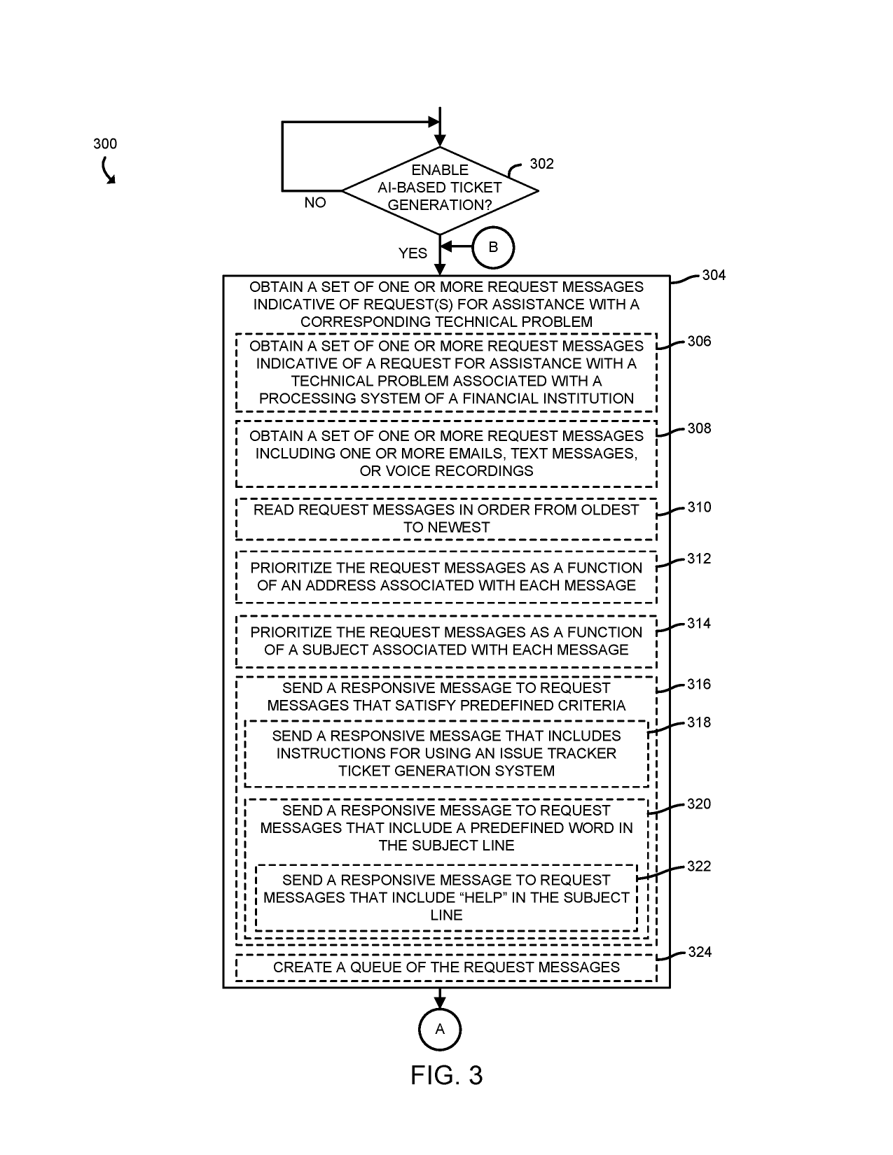

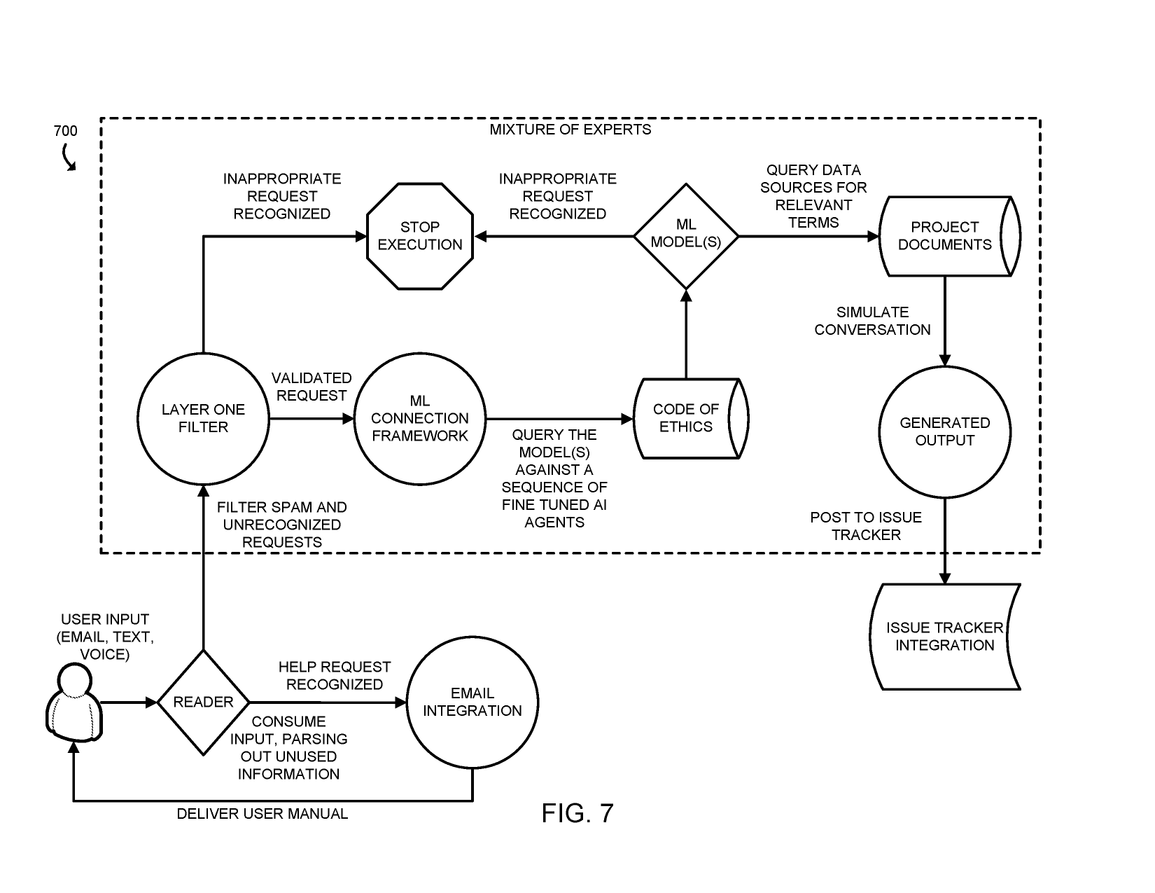

Referring now to FIG. 3, the system 100, and more specifically, the ticket generation compute device 160, in the illustrative embodiment, may perform a method 300 for artificial intelligence-based ticket generation to efficiently generate issue tracker tickets (e.g., tickets usable by the issue tracker compute device 140 and issue tracker software 150). A simplified diagram 700 representing relationships between functional components in the performance of the method is provided in FIG. 7. The method 300 begins with block 302 of FIG. 3 in which the ticket generation compute device 160 determines whether to enable artificial intelligence-based ticket generation. In doing so, the ticket generation compute device 160 may determine to enable artificial intelligence-based ticket generation in response to a determination that a configuration setting (e.g., in memory 214 or in storage 222) indicates to do so, in response to receiving a request from another compute device (e.g., 120, 140, 170, 172, 174, 176) to do so, and/or based on other factors. Regardless, in response to a determination to enable artificial intelligence-based ticket generation, the method 300 advances to block 304 in which the ticket generation compute device 160 obtains a set of one or more request messages. The request message(s), in the illustrative embodiment, are indicative of one or more requests for assistance with a corresponding technical problem. As indicated in block 306, in the illustrative embodiment, the request messages are indicative of requests for assistance with technical problems associated with a processing system (e.g., one or more of the software components 130, 132 executed by the server compute devices 120) of the financial institution 110. In obtaining a set of one or more request messages, the ticket generation compute device 160 may obtain a set of one or more request messages in the form of emails, text messages (e.g., short message service (SMS) messages, chat messages from chat messaging application(s)), and/or voice recordings, as indicated in block 308.

In the illustrative embodiment, the ticket generation compute device 160 reads (e.g., obtains) the request messages (e.g., from a queue) in the order they were received, from oldest to newest, as indicated in block 310. However, though the ticket generation compute device 160 may read the request messages in the order they were received, the ticket generation compute device 160 may prioritize the request messages as a function of (e.g., based on) an address associated with each message, as indicated in block 312. That is the, ticket generation compute device 160 may move request messages from or to a predefined address (e.g., email address, phone number, etc.) ahead in a queue relative to other request messages. Similarly, the ticket generation compute device 160 may prioritize the request messages additionally or alternatively as a function of (e.g., based on) a subject associated with each request message, as indicated in block 314. That is, the ticket generation compute device 160 may apply natural language processing or key word identification to a subject line or body of a received request message to determine a subject of the message and prioritize (e.g., move the request message ahead of other request messages) if the subject matches a predefined set of subjects designated as warranting prioritization (e.g., technical problems relating to a software component that is critical the functioning of the financial institution, technical problems related to a software component upon which a relatively large number of other software components depend, etc.).

As indicated in block 316, the ticket generation compute device 160 may send a responsive message to one or more request messages that satisfy predefined criteria. In doing so, the ticket generation compute device 160 may send a responsive message (e.g., an email or text message) that includes instructions for using an issue tracker ticket generation system (e.g., the ticket generation compute device 160), as indicated in block 318. Regarding the predefined criteria, the ticket generation compute device 160 may send a responsive message to one or more request messages that include a predefined word in the subject of the request message (e.g., in the subject line), as indicated in block 320. For example, the ticket generation compute device 160 may send a responsive message to one or more request messages that include the word “help” as indicated in block 322. As indicated in block 324, the ticket generation compute device 160 creates a queue of all of the obtained request messages (e.g., ordered according to the prioritization schemes described above).

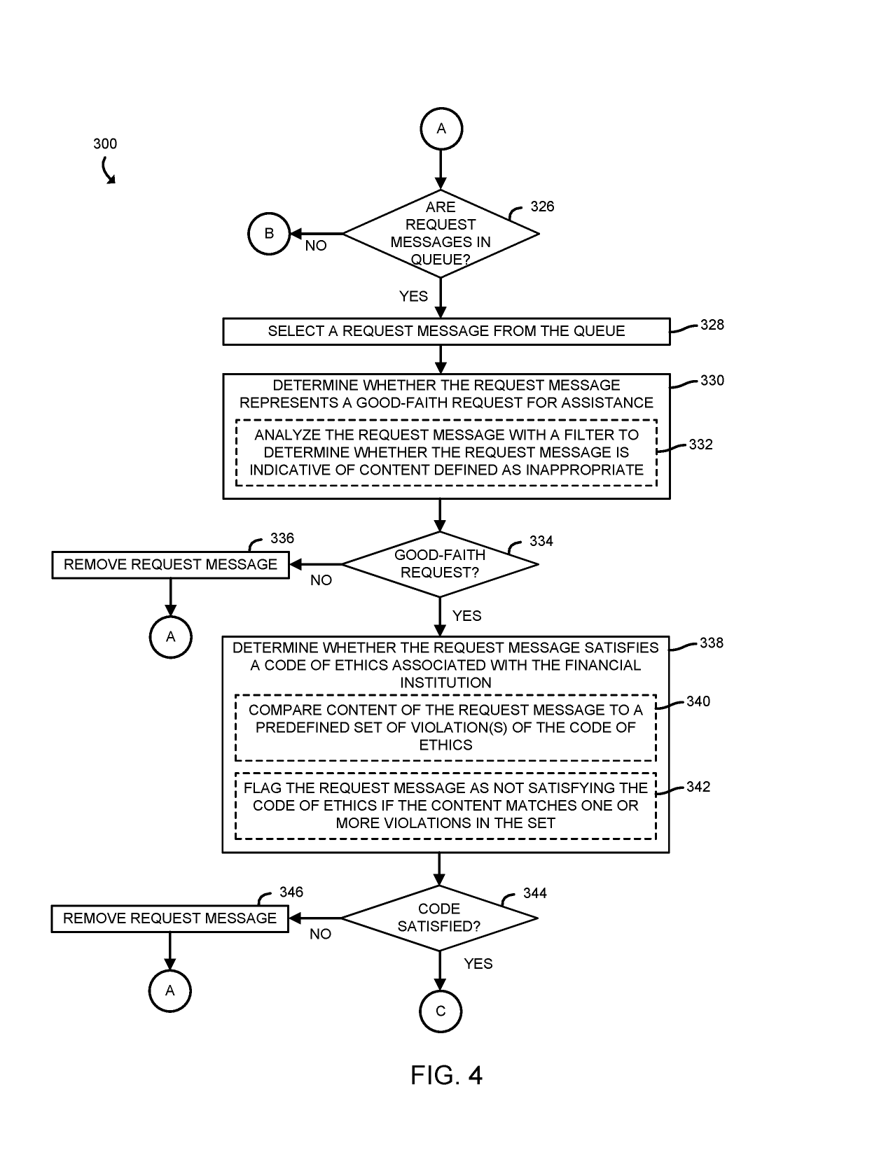

Referring now to FIG. 4, the method 300 continues to block 326 in which the ticket generation compute device 160 determines whether at least one request message is present in the queue (e.g., from block 324). If not, the method 300 loops back to block 304 to obtain one or more request messages. Otherwise (e.g., if one or more request messages are present in the queue), the method 300 advances to block 328 in which the ticket generation compute device 160 selects a request message from the queue (e.g., the first or highest priority message in the queue). In block 330, the ticket generation compute device 160 determines whether the request messages (e.g., the selected request message from block 328) represents a good-faith request for assistance with a technical problem. To do so, in the illustrative embodiment, the ticket generation compute device 160 analyzes the request message with a filter to determine whether the request message is indicative of content that has been defined as inappropriate, as indicated in block 332.

In some embodiments, the filter may be a set of predefined words indicative of content defined as inappropriate that the ticket generation compute device 160 compares to the request message, a set of rules indicative of a structure of a request message that is indicative of inappropriate content, and/or a machine learning model that has been trained to identify content deemed to be inappropriate. In block 334, the ticket generation compute device 160 determines the subsequent course of action based on whether the selected request message is indicative of a good-faith request for assistance. If not (e.g., if the selected request message is not indicative of a good-faith request for assistance, such as if the selected request message includes inappropriate content), the method 300 branches to block 336, in which the ticket generation compute device 160 removes the request message from the queue and loops back to block 326 in which the ticket generation compute device 160 determines whether any additional request messages are present in the queue. Otherwise (e.g., if the ticket generation compute device 160 determined that the request message is indicative of a good-faith request), the method 300 in the illustrative embodiment, advances to block 338 in which the ticket generation compute device 160 determines whether the request message satisfies a code of ethics (e.g., a code of ethics associated with the financial institution 110).

In determining whether the request message satisfies a code of ethics, the ticket generation compute device 160 may compare content of the request message to a predefined set of violations (e.g., predefined key words or subject matter indicative of violations of the code of ethics) of the code of ethics, as indicated in block 340. For example, if the financial institution 110 has determined not to be involved with cryptocurrencies as a policy, the predefined set of violations may include the term “cryptocurrency” as a predefined violation of the code of ethics. As such, the ticket generation compute device 160 may determine whether the request message contains the word “cryptocurrency” or may apply a machine learning model that has been trained to identify request messages pertaining to cryptocurrency while not necessarily containing that term. As indicated in block 342, the ticket generation compute device 160 flags the request message as not satisfying the code of ethics if the content of the request message matches one or more violations in the set of violations of the code of ethics for the financial institution. That is, continuing the example, the ticket generation compute device 160 may flag the request message pertaining to cryptocurrency as not satisfying the code of ethics because the content of the request message matches one of the predefined violations (e.g., cryptocurrency) of the code of ethics.

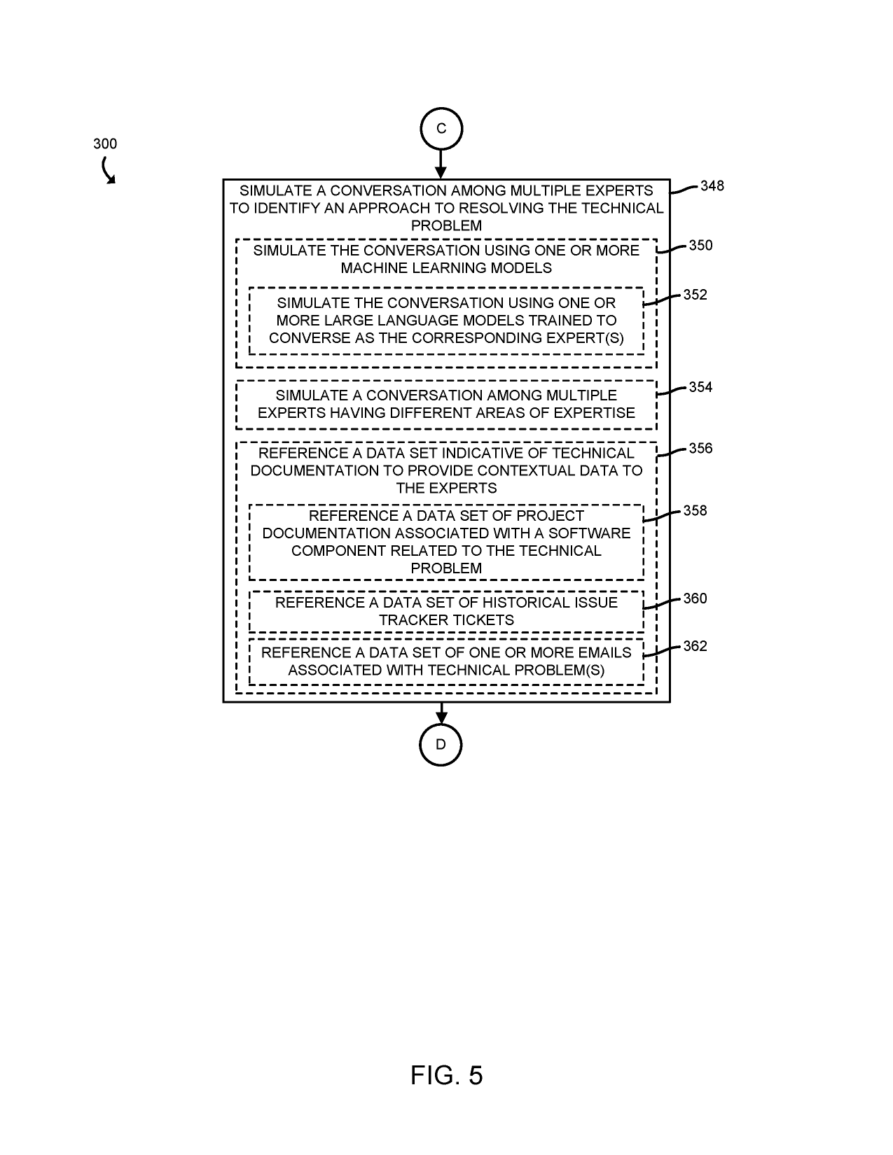

In block 344, the ticket generation compute device 160 determines the subsequent course of action based on whether the selected request messages satisfies the code of ethics. If not, the method 300 branches to block 346 in which the ticket generation compute device 160 removes the selected request message from the queue and then loops back to block 326 to determine whether any other request messages are present in the queue. Otherwise (e.g., if the code of ethics is satisfied by the selected request message), the method 300 advances to block 348 of FIG. 5, in which the ticket generation compute device 160 simulates a conversation among multiple experts (e.g., subject matter experts) to identify an approach to resolving the technical problem referenced in the selected request message. In the illustrative embodiment, the ticket generation compute device 160 simulates the conversation using one or more machine learning models, as indicated in block 350. In doing so, the ticket generation compute device 160 may utilize one or more large language models (LLMs) that have been trained to converse as corresponding subject matter experts (e.g., a technical expert, a policy or compliance expert, a project management expert, etc.), as indicated in block 352. For example, the ticket generation compute device 160 may execute a core application (e.g., a software application developed in a language such as Python) and utilize a language model integration framework (e.g., Langchain) to manage a connection to one or more large language models and a framework (e.g., LlamaIndex) for connecting a large language model to one or more sources of data. In some embodiments, the ticket generation compute device 160 may utilize a single large language model and iteratively tune and retune the large language model with the background knowledge associated with each corresponding expert, to produce the content of the simulated conversation.

In some embodiments, the ticket generation compute device 160 may utilize an interface configured for a web-browser or a Python notebook (e.g., a Jupyter notebook interface), or another other user interface, to output the simulated conversation. The ticket generation compute device 160, in some embodiments, may utilize LaMA.cpp (e.g., a LLaMA large language model implemented in C/C++) as a large language model (e.g., one of the machine learning models 162). In some embodiments, the ticket generation compute device 160 may utilize one or more other machine learning models (e.g., a large language model, such as Airoboros-l2-13b-gpt4-m2.0, that has been aligned or tuned using instructions generated by a self-aligning algorithm, such as airoboros and/or others). As indicated in block 354, in the illustrative embodiment, the ticket generation compute device 160 simulates a conversation among experts having different backgrounds, rather than the same background, thereby enabling different facets of the potential solution (e.g., technical dependencies, legal, regulatory and institutional policies to be complied with, project management goals, such as timing and resource management) to be addressed.

As indicated in block 356, the ticket generation compute device 160 references a data set (e.g., in data storage 222) indicative of technical documentation to provide contextual data to the simulated experts. For example, the ticket generation compute device 160 may utilize a framework such as LlamaIndex to connect the machine learning model(s) 162 (e.g., large language model(s)) to the data set of technical documentation. As indicated in block 358, the ticket generation compute device 160 may reference a data set of project documentation associated with a software component (e.g., a software component 130, 132) related to the technical problem. Further, the ticket generation compute device 160 may reference a data set of historical issue tracker tickets (e.g., Jira tickets) associated with the financial institution 110, as indicated in block 360, as such data may be indicative of previous solutions to similar technical problems and technical dependencies that were accounted for in those previous solutions. The ticket generation compute device 160 may also reference a data set of one or more emails associated with technical problems, as indicated in block 362, as those emails may include descriptions of technical problems, solutions to the problems, and technical, regulatory, and managerial issues that were addressed in formulating the solutions to the technical problems. In the illustrative embodiment, the ticket generation compute device 160 stores a record (e.g., in data storage 222) of the simulated conversation (e.g., as a text file).

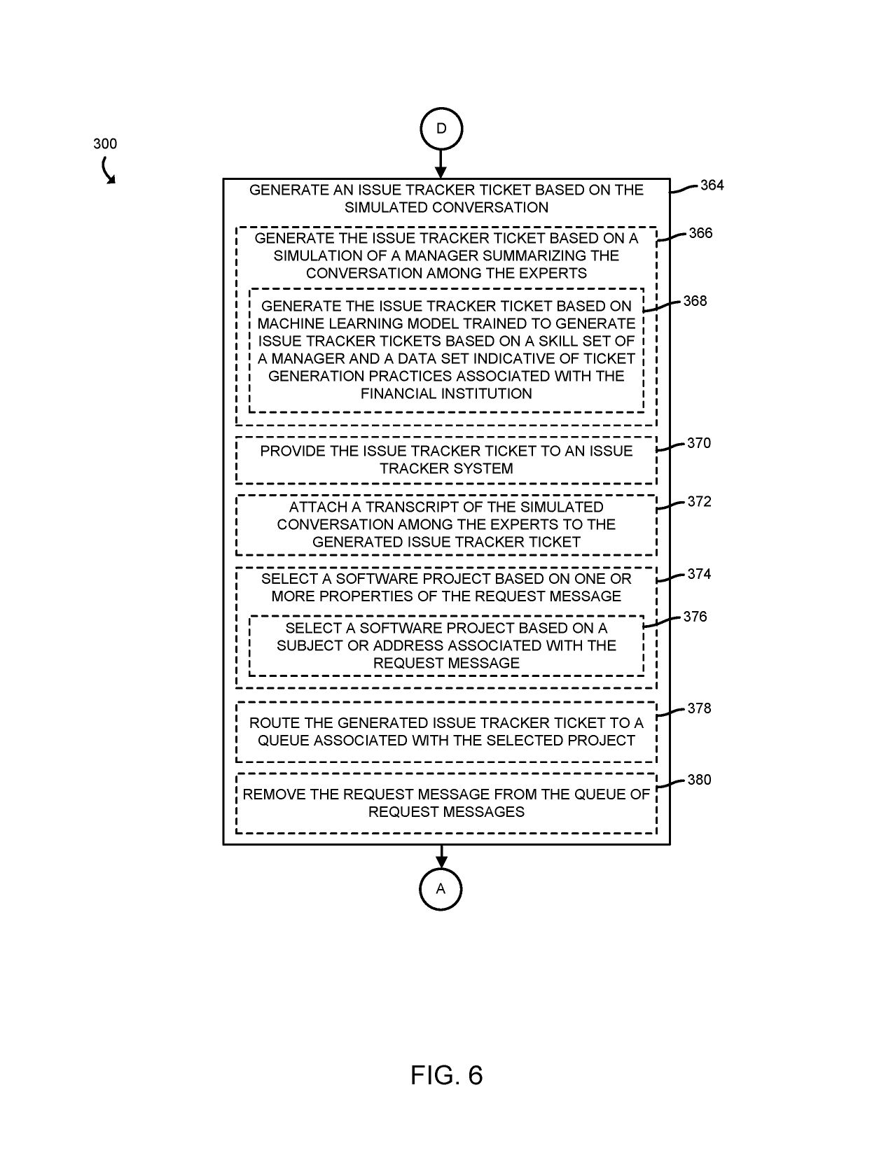

Referring now to FIG. 6, continuing the method 300, the ticket generation compute device 160 generates an issue tracker ticket based on the simulated conversation, as indicated in block 364. In generating an issue tracker ticket, the ticket generation compute device 160 may simulate a manager summarizing the conversation among the experts (e.g., for a summary portion of the issue tracker ticket), as indicated in block 366. In the illustrative embodiment, the ticket generation compute device 160 generates the issue tracker ticket (e.g., Jira ticket) based on a machine learning model (e.g., a large language model) that has been trained to generate issue tracker tickets based on a skill set of a manager and a data set indicative of ticket generation practices adopted by the financial institution, as indicated in block 368. For example, the large language model may be trained based on historical tickets that satisfy the formatting requirements of the issue tracker software 150 and any best practices (e.g., word choice, formatting, grouping of information within a summary, types of data to be included) implemented by the financial institution 110, as represented within historical issue tracker tickets and/or as described in one or more documents (e.g., manuals) associated with the financial institution 110.

As indicated in block 370, the ticket generation compute device 160 provides the issue tracker ticket (e.g., generated by the ticket generation compute device 160) to an issue tracker system (e.g., the issue tracker compute device 140 executing the issue tracker software 150). The ticket generation compute device 160 may do so by executing an application programming interface (API) call (e.g., a representational state transfer (REST) API call), sending the ticket to a predefined email address that the issue tracker compute device 140 is configured to read from, and/or through one or more other methods. In the illustrative embodiment, the ticket generation compute device 160 attaches a transcript (e.g., record, such as a text file) of the simulated conversation among the experts to the generated issue tracker ticket (e.g., by embedding or appending the data representing the transcript to a data set representing the generated issue tracker ticket, by associating a link or reference to a data set indicative of the transcript to the data set representing the generated issue tracker ticket, etc.), as indicated in block 372.

The ticket generation compute device 160 may select a software project (e.g., a software component 130, 132) based on one or more properties of the selected request message (e.g., the request message selected in block 328 of FIG. 4), as indicated in block 374. In doing so, in the illustrative embodiment, the ticket generation compute device 160 may select a software project (e.g., a software component 130, 132) based on a subject or address associated with the request message, as indicated in block 376. For example, the ticket generation compute device 160 may compare the determined subject of the request message to a data set indicative of titles or descriptions of the software projects (e.g., software components 130, 132) to select a corresponding software project (e.g., the software project with a name or description that most closely matches the determined subject, as indicated by a Levenshtein distance, Hamming distance, or other string comparison executed by the ticket generation compute device 160).

In selecting a software project based on an address associated with the request message, the ticket generation compute device 160 may compare the address (e.g., origin address or destination address) to data set of addresses associated with the various projects (e.g., software components 130, 132) to find a match (e.g., the software project to be selected). For example, various employees may be assigned to utilize or test a particular software project (e.g., a software component 130, 132) and a list of email addresses of those employees may be stored (e.g., a in the data store 222) in connection with the software project. As such, if the request message originated from an email address in that list, the ticket generation compute device 160 may select the corresponding software project after preforming the above-described look up. The ticket generating compute device 160 may read from multiple inboxes associated with different email address, each associate with different one of the software projects (e.g., software components 130,132). As such by comparing the address to which the selected request message was sent (e.g., the destination address) to a data set indicating a mapping between destination addresses and software projects, the ticket generation compute device 160 may determine and select the corresponding software project. As indicated in block 378, the ticket generation compute device 160 may route the generated issue tracker ticket to a queue associated with the selected project. Having performed operations described above for the selected request message, and as indicated in block 380, the ticket generation compute device 160 removes the selected request message from the queue of request messages and the method 300 loops back to block 326 to FIG. 4 to determine whether any additional request message are present in the queue.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. For example, while the above methods and systems are described in connection with a financial institution (e.g., the financial institution 110), it will be appreciated by those skilled in the art that the methods and systems could be equally used in the context of other institutions or organizations. Additionally, while the methods and systems are described in the context of simulating a conversation among experts to produce content for an issue tracker ticket, in other embodiments, the methods and systems may be applied to producing content for other items, such as a sales brief describing a business opportunity for an organization, by simulating one or more conversations among corresponding experts (e.g., an expert in treasury management, a retail sales expert, an expert in corporate or institutional policies and practices, etc.). There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain a request message indicative of a request for assistance with a corresponding technical problem; simulate a conversation among multiple experts to identify an approach to resolving the technical problem; and generate an issue tracker ticket based on the simulated conversation.

Example 2 includes the subject matter of Example 1, and wherein to simulate a conversation comprises to simulate a conversation using one or more machine learning models.

Example 3 includes the subject matter of any of Examples 1 and 2, and wherein to simulate a conversation using one or more machine learning models comprises to simulate a conversation using one or more large language models trained to converse as each of the corresponding experts.

Example 4 includes the subject matter of any of Examples 1-3, and wherein to simulate the conversation comprises to simulate a conversation among multiple experts having different areas of expertise.

Example 5 includes the subject matter of any of Examples 1-4, and wherein the circuitry is further configured to reference a data set indicative of technical documentation to provide contextual data to the experts.

Example 6 includes the subject matter of any of Examples 1-5, and wherein to reference a data set indicative of technical documentation comprises to reference a data set of project documentation associated with a software component related to the technical problem.

Example 7 includes the subject matter of any of Examples 1-6, and wherein to reference a data set indicative of technical documentation comprises to reference a data set of historical issue tracker tickets.

Example 8 includes the subject matter of any of Examples 1-7, and wherein to reference a data set indicative of technical documentation comprises to reference a data set of emails associated with technical problems.

Example 9 includes the subject matter of any of Examples 1-8, and wherein the circuitry is further configured to determine whether the request message represents a good-faith request for assistance; and determine, in response to a determination that the request message represents a good-faith request for assistance, whether the request message satisfies a code of ethics; and wherein to simulate a conversation comprises to simulate the conversation in response to a determination that the request message represents a good-faith request for assistance and that the request message satisfies the code of ethics.

Example 10 includes the subject matter of any of Examples 1-9, and wherein to determine whether the request message represents a good-faith request for assistance comprises to analyze the request message with a filter to determine whether the request message is indicative of content defined as inappropriate.

Example 11 includes the subject matter of any of Examples 1-10, and wherein to determine whether the request message represents a good-faith request for assistance comprises to compare content of the request message to a predefined set of violations of the code of ethics to determine whether the content matches one or more of the violations in the set.

Example 12 includes the subject matter of any of Examples 1-11, and wherein to generate an issue tracker ticket based on the simulated conversation comprises to generate the issue tracker ticket based on a simulation of a manager summarizing the conversation.

Example 13 includes the subject matter of any of Examples 1-12, and wherein to generate the issue tracker ticket based on a simulation of a manager summarizing the conversation comprises to generate the issue tracker ticket based on a machine learning model trained to generate issue tracker tickets based on a skill set of a manager and a data set indicative of ticket generation practices associated with an institution.

Example 14 includes the subject matter of any of Examples 1-13, and wherein the circuitry is further configured to provide the issue tracker ticket to an issue tracker system.

Example 15 includes the subject matter of any of Examples 1-14, and wherein the circuitry is further configured to attach a transcript of the simulated conversation among the experts to the generated issue tracker ticket.

Example 16 includes the subject matter of any of Examples 1-15, and wherein the circuitry is further configured to select a software project based on one or more properties of the request message; and route the generated issue tracker ticket to a queue associated with the selected software project.

Example 17 includes the subject matter of any of Examples 1-16, and wherein the circuitry is further configured to remove the request message from a queue after the issue tracker ticket has been generated.

Example 18 includes the subject matter of any of Examples 1-17, and wherein to obtain a request message comprises to obtain a request message indicative of a request for assistance with a technical problem associated with a processing system of a financial institution.

Example 19 includes the subject matter of any of Examples 1-18, and wherein to obtain a request message comprises to obtain a request message formatted as an email, a text message, or a voice recording.

Example 20 includes the subject matter of any of Examples 1-19, and wherein the request message is a first request message in a set of multiple request messages and the circuitry is further configured to prioritize the request messages as a function of at least one of a subject associated with each request message or an address associated with each request message.

Example 21 includes the subject matter of any of Examples 1-20, and wherein the circuitry is further configured to send, in response to the request message, a responsive message that includes a set of instructions.

Example 22 includes the subject matter of any of Examples 1-21, and wherein the circuitry is further configured to determine whether the request message contains a predefined word; and send, in response to a determination that the request message contains the predefined word, a responsive message.

Example 23 includes the subject matter of any of Examples 1-22, and wherein the request message is a first request message and the circuitry is further configured to create a queue of multiple request messages, including the first request message.

Example 24 includes a method comprising obtaining, by a compute device, a request message indicative of a request for assistance with a corresponding technical problem; simulating, by the compute device, a conversation among multiple experts to identify an approach to resolving the technical problem; and generating, by the compute device, an issue tracker ticket based on the simulated conversation.

Example 25 includes the subject matter of Example 24, and wherein simulating a conversation comprises simulating a conversation using one or more machine learning models.

Example 26 includes the subject matter of any of Examples 24 and 25, and wherein simulating a conversation using one or more machine learning models comprises simulating a conversation using one or more large language models trained to converse as each of the corresponding experts.

Example 27 includes the subject matter of any of Examples 24-26, and wherein simulating the conversation comprises simulating a conversation among multiple experts having different areas of expertise.

Example 28 includes the subject matter of any of Examples 24-27, and further including referencing, by the compute device, a data set indicative of technical documentation to provide contextual data to the experts.

Example 29 includes the subject matter of any of Examples 24-28, and wherein referencing a data set indicative of technical documentation comprises referencing a data set of project documentation associated with a software component related to the technical problem.

Example 30 includes the subject matter of any of Examples 24-29, and wherein referencing a data set indicative of technical documentation comprises referencing a data set of historical issue tracker tickets.

Example 31 includes the subject matter of any of Examples 24-30, and wherein referencing a data set indicative of technical documentation comprises referencing a data set of emails associated with technical problems.

Example 32 includes the subject matter of any of Examples 24-31, and further including determining, by the compute device, whether the request message represents a good-faith request for assistance; and determining, by the compute device and in response to a determination that the request message represents a good-faith request for assistance, whether the request message satisfies a code of ethics; and wherein simulating a conversation comprises simulating the conversation in response to a determination that the request message represents a good-faith request for assistance and that the request message satisfies the code of ethics.

Example 33 includes the subject matter of any of Examples 24-32, and wherein determining whether the request message represents a good-faith request for assistance comprises analyzing the request message with a filter to determine whether the request message is indicative of content defined as inappropriate.

Example 34 includes the subject matter of any of Examples 24-33, and wherein determining whether the request message represents a good-faith request for assistance comprises comparing content of the request message to a predefined set of violations of the code of ethics to determine whether the content matches one or more of the violations in the set.

Example 35 includes the subject matter of any of Examples 24-34, and wherein generating an issue tracker ticket based on the simulated conversation comprises generating the issue tracker ticket based on a simulation of a manager summarizing the conversation.

Example 36 includes the subject matter of any of Examples 24-35, and wherein generating the issue tracker ticket based on a simulation of a manager summarizing the conversation comprises generating the issue tracker ticket based on a machine learning model trained to generate issue tracker tickets based on a skill set of a manager and a data set indicative of ticket generation practices associated with an institution.

Example 37 includes the subject matter of any of Examples 24-36, and further including providing, by the compute device, the issue tracker ticket to an issue tracker system.

Example 38 includes the subject matter of any of Examples 24-37, and further including attaching, by the compute device, a transcript of the simulated conversation among the experts to the generated issue tracker ticket.

Example 39 includes the subject matter of any of Examples 24-38, and further including selecting, by the compute device, a software project based on one or more properties of the request message; and routing, by the compute device, the generated issue tracker ticket to a queue associated with the selected software project.

Example 40 includes the subject matter of any of Examples 24-39, and further including removing, by the compute device, the request message from a queue after the issue tracker ticket has been generated.

Example 41 includes the subject matter of any of Examples 24-40, and wherein obtaining a request message comprises obtaining a request message indicative of a request for assistance with a technical problem associated with a processing system of a financial institution.

Example 42 includes the subject matter of any of Examples 24-41, and wherein obtaining a request message comprises obtaining a request message formatted as an email, a text message, or a voice recording.

Example 43 includes the subject matter of any of Examples 24-42, and wherein the request message is a first request message in a set of multiple request messages and the method further comprises prioritizing, by the compute device, the request messages as a function of at least one of a subject associated with each request message or an address associated with each request message.

Example 44 includes the subject matter of any of Examples 24-43, and further including sending, by the compute device and in response to the request message, a responsive message that includes a set of instructions.

Example 45 includes the subject matter of any of Examples 24-44, and further including determining, by the compute device, whether the request message contains a predefined word; and sending, by the compute device and in response to a determination that the request message contains the predefined word, a responsive message.

Example 46 includes the subject matter of any of Examples 24-45, and wherein the request message is a first request message and the method further comprises creating, by the compute device, a queue of multiple request messages, including the first request message.

Example 47 includes one or more machine-readable storage media comprising a plurality of instructions stored thereon that, in response to being executed, cause a compute device to obtain a request message indicative of a request for assistance with a corresponding technical problem; simulate a conversation among multiple experts to identify an approach to resolving the technical problem; and generate an issue tracker ticket based on the simulated conversation.

Example 48 includes the subject matter of Example 47, and wherein to simulate a conversation comprises to simulate a conversation using one or more machine learning models.

Example 49 includes the subject matter of any of Examples 47 and 48, and wherein to simulate a conversation using one or more machine learning models comprises to simulate a conversation using one or more large language models trained to converse as each of the corresponding experts.

Example 50 includes the subject matter of any of Examples 47-49, and wherein to simulate the conversation comprises to simulate a conversation among multiple experts having different areas of expertise.

Example 51 includes the subject matter of any of Examples 47-50, and wherein the instructions further cause the compute device to reference a data set indicative of technical documentation to provide contextual data to the experts.

Example 52 includes the subject matter of any of Examples 47-51, and wherein to reference a data set indicative of technical documentation comprises to reference a data set of project documentation associated with a software component related to the technical problem.

Example 53 includes the subject matter of any of Examples 47-52, and wherein to reference a data set indicative of technical documentation comprises to reference a data set of historical issue tracker tickets.

Example 54 includes the subject matter of any of Examples 47-53, and wherein to reference a data set indicative of technical documentation comprises to reference a data set of emails associated with technical problems.

Example 55 includes the subject matter of any of Examples 47-54, and wherein the instructions additionally cause the compute device to determine whether the request message represents a good-faith request for assistance; and determine, in response to a determination that the request message represents a good-faith request for assistance, whether the request message satisfies a code of ethics; and wherein to simulate a conversation comprises to simulate the conversation in response to a determination that the request message represents a good-faith request for assistance and that the request message satisfies the code of ethics.

Example 56 includes the subject matter of any of Examples 47-55, and wherein to determine whether the request message represents a good-faith request for assistance comprises to analyze the request message with a filter to determine whether the request message is indicative of content defined as inappropriate.

Example 57 includes the subject matter of any of Examples 47-56, and wherein to determine whether the request message represents a good-faith request for assistance comprises to compare content of the request message to a predefined set of violations of the code of ethics to determine whether the content matches one or more of the violations in the set.

Example 58 includes the subject matter of any of Examples 47-57, and wherein to generate an issue tracker ticket based on the simulated conversation comprises to generate the issue tracker ticket based on a simulation of a manager summarizing the conversation.

Example 59 includes the subject matter of any of Examples 47-58, and wherein to generate the issue tracker ticket based on a simulation of a manager summarizing the conversation comprises to generate the issue tracker ticket based on a machine learning model trained to generate issue tracker tickets based on a skill set of a manager and a data set indicative of ticket generation practices associated with an institution.

Example 60 includes the subject matter of any of Examples 47-59, and wherein the instructions additionally cause the compute device to provide the issue tracker ticket to an issue tracker system.

Example 61 includes the subject matter of any of Examples 47-60, and wherein the instructions additionally cause the compute device to attach a transcript of the simulated conversation among the experts to the generated issue tracker ticket.

Example 62 includes the subject matter of any of Examples 47-61, and wherein the instructions additionally cause the compute device to select a software project based on one or more properties of the request message; and route the generated issue tracker ticket to a queue associated with the selected software project.

Example 63 includes the subject matter of any of Examples 47-62, and wherein the instructions additionally cause the compute device to remove the request message from a queue after the issue tracker ticket has been generated.

Example 64 includes the subject matter of any of Examples 47-63, and wherein to obtain a request message comprises to obtain a request message indicative of a request for assistance with a technical problem associated with a processing system of a financial institution.

Example 65 includes the subject matter of any of Examples 47-64, and wherein to obtain a request message comprises to obtain a request message formatted as an email, a text message, or a voice recording.

Example 66 includes the subject matter of any of Examples 47-65, and wherein the request message is a first request message in a set of multiple request messages and the instructions further cause the compute device to prioritize the request messages as a function of at least one of a subject associated with each request message or an address associated with each request message.

Example 67 includes the subject matter of any of Examples 47-66, and wherein the instructions further cause the compute device to send, in response to the request message, a responsive message that includes a set of instructions.

Example 68 includes the subject matter of any of Examples 47-67, and wherein the instructions further cause the compute device to determine whether the request message contains a predefined word; and send, in response to a determination that the request message contains the predefined word, a responsive message.

Example 69 includes the subject matter of any of Examples 47-68, and wherein the request message is a first request message and the instructions further cause the compute device to create a queue of multiple request messages, including the first request message.

1. A compute device comprising:
circuitry configured to:obtain a request message indicative of a request for assistance with a corresponding technical problem;simulate a conversation among multiple experts to identify an approach to resolving the technical problem; andgenerate an issue tracker ticket based on the simulated conversation.

2. The compute device of claim 1, wherein to simulate a conversation comprises to simulate a conversation using one or more machine learning models.

3. The compute device of claim 2, wherein to simulate a conversation using one or more machine learning models comprises to simulate a conversation using one or more large language models trained to converse as each of the corresponding experts.

4. The compute device of claim 1, wherein to simulate the conversation comprises to simulate a conversation among multiple experts having different areas of expertise.

5. The compute device of claim 1, wherein the circuitry is further configured to reference a data set indicative of technical documentation to provide contextual data to the experts, wherein to reference a data set indicative of technical documentation comprises to reference: (i) a data set of project documentation associated with a software component related to the technical problem; (ii) a data set of historical issue tracker tickets; and/or (iii) a data set of emails associated with technical problems.

6. The compute device of claim 1, wherein the circuitry is further configured to:
determine whether the request message represents a good-faith request for assistance comprising: (i) to analyze the request message with a filter to determine whether the request message is indicative of content defined as inappropriate; and (ii) to compare content of the request message to a predefined set of violations of the code of ethics to determine whether the content matches one or more of the violations in the set;
determine, in response to a determination that the request message represents a good-faith request for assistance, whether the request message satisfies a code of ethics; and
wherein to simulate a conversation comprises to simulate the conversation in response to a determination that the request message represents a good-faith request for assistance and that the request message satisfies the code of ethics.

7. The compute device of claim 1, wherein to generate an issue tracker ticket based on the simulated conversation comprises to generate the issue tracker ticket based on a simulation of a manager summarizing the conversation.

8. The compute device of claim 7, wherein to generate the issue tracker ticket based on a simulation of a manager summarizing the conversation comprises to generate the issue tracker ticket based on a machine learning model trained to generate issue tracker tickets based on a skill set of a manager and a data set indicative of ticket generation practices associated with an institution.

9. The compute device of claim 1, wherein the circuitry is further configured to provide the issue tracker ticket to an issue tracker system.

10. The compute device of claim 1, wherein the circuitry is further configured to attach a transcript of the simulated conversation among the experts to the generated issue tracker ticket.

11. The compute device of claim 1, wherein the circuitry is further configured to:
select a software project based on one or more properties of the request message; and
route the generated issue tracker ticket to a queue associated with the selected software project.

12. The compute device of claim 1, wherein the circuitry is further configured to remove the request message from a queue after the issue tracker ticket has been generated.

13. The compute device of claim 1, wherein to obtain a request message comprises to obtain a request message indicative of a request for assistance with a technical problem associated with a processing system of a financial institution.

14. The compute device of claim 1, wherein to obtain a request message comprises to obtain a request message formatted as an email, a text message, or a voice recording.

15. The compute device of claim 1, wherein the request message is a first request message in a set of multiple request messages and the circuitry is further configured to prioritize the request messages as a function of at least one of a subject associated with each request message or an address associated with each request message.

16. The compute device of claim 1, wherein the circuitry is further configured to send, in response to the request message, a responsive message that includes a set of instructions.

17. The compute device of claim 1, wherein the circuitry is further configured to:
determine whether the request message contains a predefined word; and
send, in response to a determination that the request message contains the predefined word, a responsive message.

18. The compute device of claim 1, wherein the request message is a first request message and the circuitry is further configured to create a queue of multiple request messages, including the first request message.

19. A method comprising:
obtaining, by a compute device, a request message indicative of a request for assistance with a corresponding technical problem;simulating, by the compute device, a conversation among multiple experts to identify an approach to resolving the technical problem; andgenerating, by the compute device, an issue tracker ticket based on the simulated conversation.

20. The method of claim 19, wherein simulating a conversation comprises simulating a conversation using one or more machine learning models, wherein simulating a conversation using one or more machine learning models comprises simulating a conversation using one or more large language models trained to converse as each of the corresponding experts, wherein the multiple experts have different areas of expertise.

21. The method of claim 20, further comprising:
determining, by the compute device, whether the request message represents a good-faith request for assistance; and
determining, by the compute device and in response to a determination that the request message represents a good-faith request for assistance, whether the request message satisfies a code of ethics; and
wherein simulating a conversation comprises simulating the conversation in response to a determination that the request message represents a good-faith request for assistance and that the request message satisfies the code of ethics.

22. The method of claim 21, wherein determining whether the request message represents a good-faith request for assistance comprises: (i) analyzing the request message with a filter to determine whether the request message is indicative of content defined as inappropriate; and/or (ii) comparing content of the request message to a predefined set of violations of the code of ethics to determine whether the content matches one or more of the violations in the set.

23. The method of claim 22, wherein generating an issue tracker ticket based on the simulated conversation comprises: (i) generating the issue tracker ticket based on a simulation of a manager summarizing the conversation; and/or (ii) generating the issue tracker ticket based on a machine learning model trained to generate issue tracker tickets based on a skill set of a manager and a data set indicative of ticket generation practices associated with an institution.

24. The method of claim 23, further comprising:
selecting, by the compute device, a software project based on one or more properties of the request message; and
routing, by the compute device, the generated issue tracker ticket to a queue associated with the selected software project.

25. The method of claim 24, wherein the request message is a first request message in a set of multiple request messages and the method further comprises prioritizing, by the compute device, the request messages as a function of at least one of a subject associated with each request message or an address associated with each request message.
